(19) United States
(12) Patent Application Publication
(10) Pub. No.: US 2026/0288084 A1
(43) Pub. Date: Sep. 24, 2026

(54) SPACE VEHICLE TIME CONSIDERING SPECIAL RELATIVITY

(71) Applicant: Raytheon Company, Arlington, VA (US)

(72) Inventors: Marcus A. Teter, Belgrade, MT (US); Scott Allen Imhoff, Centennial, CO (US); Douglas B. Tyler, Torrance, CA (US)

(21) Appl. No.: 19/087,067

(22) Filed: Mar. 21, 2025

(51) Int. Cl. G04R 20/00; B64G 3/00

(52) U.S. Cl. CPC G04R 20/00; B64G 3/00

(57) ABSTRACT

Systems, devices, methods, and computer-readable media for special relativity considerations in space vehicles. A method can include receiving space vehicle data including a time delta or ephemeris data from a second space vehicle of the constellation, altering, by processing circuitry, the space vehicle data based on a ratio that includes relative speeds of the first space vehicle and the second space vehicle and speed of light, resulting in special relativity data, estimating, by a Kalman filter and based on the special relativity data, an actual time delta or actual ephemeris data, and adjusting an internal clock time or ephemeris data of the first space vehicle based on the actual time delta or the actual ephemeris data, respectively, resulting in adjusted internal clock time or adjusted ephemeris data, and communicating the adjusted internal clock time or the adjusted ephemeris data to another space vehicle in the constellation of space vehicles.

### BACKGROUND

Clocks on space vehicles in a constellation require periodic updates to keep them in sync with master clocks on the ground. The accuracy of the positioning solution obtained from those space vehicles in their constellation is dependent on the accuracy of their own clocks as well as that of the clocks of other space vehicles in the constellation. Time accuracy δt is convertible into positioning accuracy δx through the equation δx=c×δt. How does a space vehicle make that periodic or occasional update to space vehicle and ensemble clocks if it is unable to communicate with the master clock on the ground?

### BRIEF DESCRIPTION OF DRAWINGS

FIG. 1 illustrates, by way of example, an embodiment of a system that operates to account for special relativistic effects in space vehicles.

FIG. 2 illustrates, by way of example, a diagram of an embodiment of processing circuitry for accounting for special relativistic effects in space vehicles.

FIG. 3 illustrates, by way of example, a flow diagram of a method for special relativity consideration in ensemble time determination.

FIGS. 4 and 5 illustrate graphs that plot actual γ and β values, respectively, along with their relative variation.

FIG. 6 illustrates, by way of example, a graph 660 of space vehicle position determination using Kalman filter operations that can help understand the operations of Kalman filters.

FIG. 7 illustrates, by way of example, a diagram of an embodiment of a method for improved space vehicle time/location determination.

FIG. 8 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

For a space vehicle constellation, such as a low earth orbit (LEO) constellation of space vehicles, an ensemble time is determined. The ensemble time can be determined when the space vehicle is unable to communicate with a ground station that maintains a master clock time. Without the time correction, the inaccurate time of the space vehicle causes a reduction in position accuracy for the space vehicle and for the constellation of which it is a part. Any downstream use of the position, such as targeting, is affected by this reduction in position accuracy.

Embodiments provide an ability for a set of clocks to synchronize with each other well enough to create an accurate ensemble time. The clock synchronization comes from an idea that metronomes end up coupled with each other via a common surface on which they reside. The small signals between the metronomes communicate tiny impulses of their state via a shift in the platforms position to their neighbors. After a certain amount of time the metronomes begin beating in phase at the same frequency. This coupling of the metronomes is an exchange of information. Coupling of clocks on space vehicles can be realized using a radio frequency (RF) two-way timing (TWT) signal. The TWT signal can form an ensemble time, and by extension improve the quality of an on-board Kalman filter that provides the position of the space vehicle.

In embodiments, a set of Kalman filters, operating in parallel in a given space vehicle, samples other clocks of space vehicles in the constellation. A tracked ensemble time becomes a means to correct an internal clock of the space vehicle. After the clock has been adjusted based on the ensemble time, the process resumes improving the clock to be more consistent with the clocks of the ensemble. This process running over the system makes these corrections on a space vehicle-by-space vehicle basis until the ensemble time maintains an ensemble time with high fidelity.

Embodiments can determine clock state data, ephemeris state data, or a combination thereof using the processing of measurements from other space vehicles of the constellation. The measurements consist of time references of the ensemble time. Those times are processed through clock Kalman filters running in parallel. The clock Kalman filters determine the state of respective space vehicles internal clock as compared with the measurements of the ensemble time. Those time states created by the N individual Kalman filters, where N is an integer, are updated through a clock conditioner. On another processing path, an ephemeris Kalman filter processes the time measurements into an ephemeris state vector. Outputs from the system feed the various payloads of the space vehicle. N=M−1, where M is the number of space vehicles in the constellation.

In intra-plane TWT, considering the speeds of the space vehicles, special relativity affects the time of the space vehicles in an appreciable manner. In creating the ensemble time, relativistic differences in time can be considered to generate a more accurate ensemble time. However, values in special relativity, such as the relativity parameter gamma are often sized incorrectly to have an impact on Kalman filter performance.

Instead of using a small non-varying part of relativity parameters and scaled velocities, embodiments can change an element in a Kalman filter state vector. Typically, a gamma parameter is used to determine an effect of special relativity. Embodiments can instead to use a log of gamma or subtract gamma from unity (“1”) (or subtract unity from gamma). Using the log scales the parameter and the subtraction of unity highlights the varying portion of the parameter. This becomes especially important when the Kalman filter covariance is calculated.

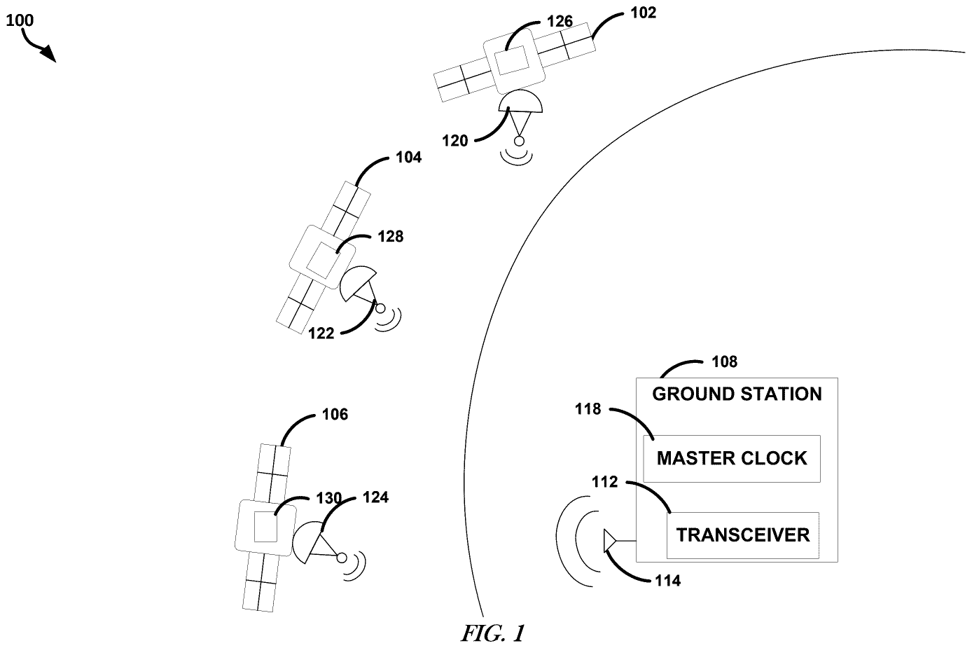

FIG. 1 illustrates, by way of example, an embodiment of a system 100 that operates to account for special relativistic effects in space vehicles. The system 100 as illustrated includes a constellation of space vehicles 102, 104, 106, and a ground station 108. For accurate time determination, the ground station 108 can provide a time from a master clock 118 to each space vehicle 102, 104, 106 of the constellation, such as by issuing a communication using a transceiver 112 and an antenna 114.

The space vehicle 102, 104, 106 can include a communication, remote sensing (e.g., weather, electromagnetic sensing, radar, lidar, or the like), navigation (e.g., global positioning system (GPS), Galileo, or the like), internet, radio, television, manned, unmanned, or other space vehicle. The space vehicle 102, 104, 106 is generally any device capable of communication with the ground station 108. The space vehicle 102, 104, 106 can be orbiting the Earth, whether in low Earth orbit (LEO), medium Earth orbit (MEO), or high Earth orbit (HEO) or could be a naturally occurring celestial body external to the Earth.

The space vehicle 102, 104, 106 as illustrated includes respective antennae 120, 122, 124. The antenna 120, 122, 124 can convert modulated electrical signals to an electromagnetic wave that is transmitted to the ground station 108. The data modulated onto the wave can include Keplerian element data, or equivalent navigational content or a time as provided by a clock 126, 128, 130. The clock 126, 128, 130 of a space vehicle 102, 104, 106 is often not as accurate as the clock 118 of the ground station 108.

Locations of space vehicles 102, 104, 106 can be determined using tracking from the ground station 108. The ground station 108 uses mechanisms, such as radar, signal Doppler, and laser reflectors or measurement of time delay in a time-tagged signal received passively to pinpoint the position of a space vehicle and to maintain an understanding of its orbital elements. Given Keplerian orbital elements, or the equivalent representation of spatiotemporal position, orbital mechanics can be used to calculate where the space vehicle 102, 104, 106 is at a specific point in time, which may be instantiated by a multilateration performed by user equipment. The Keplerian elements are: epoch time that indicates the time at which the other values, inclination that indicates the angle between the equator and the orbit plane, eccentricity which is a constant defining the shape of the orbit (e.g., 0=circular, <1=elliptical), length of semi-major axis that is a constant defining the size of the orbit, true anomaly which indicates the angle between perigee and the space vehicle 102 (in the orbit plane), right ascension of the ascending node, the angle between vernal equinox and the point where the orbit crosses the equatorial plane (going north), and argument of perigee that indicates the angle between the ascending node and the orbit's point of closest approach to the earth (perigee). This information can be tabulated in an ephemeris (a table). Given the Keplerian elements, or the equivalent, and a time stamp from the space vehicle 102, 104, 106 the ground station 108 or space vehicle 102, 104, 106 can calculate the position of the space vehicle 102, 104, 106 by performing multilateration.

Additionally, or alternatively, trilateration can be used by the ground station 108 to determine the position of the space vehicle 102, 104, 106. The ground station 108 can each receive a communication from the space vehicle 102, 104, 106. A time between the transmission of communication at the space vehicle 102, 104, 106 and reception of the communication at the ground station 108 can indicate how far away the space vehicle 102, 104, 106 is from the ground station 108. The distance to the ground station 108 can be used to determine the position of the space vehicle 102, 104, 106. This technique of space vehicle position determination tends to be more accurate than the determination using the Keplerian elements.

The ground station 108 as illustrated includes a transceiver 112 and an antenna 114. The transceiver 112 modulates data to be provided to the ground station 108 and receive electrical signals from the space vehicle 102, 104, 106. The data to the station 108 can include a time between transmission of a communication from the space vehicle 102, 104, 106. The data to the ground station 108 can further include sensor data the space vehicle 102, 104, 106.

The master clock 118 retains a more accurate time than the space vehicles 102, 104, 106 are capable of retaining. The master clock 118 can be an atomic clock. The ground station 108 can communicate the time from the master clock 118 to the space vehicles 102, 104, 106.

The ground station 108 acts as a data processing center for information from the space vehicles 102, 104, 106. Orbit coordinates can be determined by trilateration and the orbit model (ephemeris). When the space vehicle drifts out of expected orbit, repositioning can be undertaken. The clock 126, 128, 130 may also be readjusted, but more usually information on time errors is attached to signals as correction factors. The computed corrections, time readjustments and repositioning information can be transmitted to the space vehicle via an uplink from the ground station 108.

However, sometimes one or more of the space vehicles 102, 104, 106 is out of communication range of the ground station 108. When one or more of the space vehicles 102, 104, 106 is out of communication range, the clock 126, 128, 130 of the space vehicles 102, 104, 106 may be incorrect or otherwise out of sync with the master clock 118. The space vehicles 102, 104, 106, since their position determination depends on time, a space vehicle 102, 104, 106 with an incorrect time will not have an accurate position.

Embodiments allow the space vehicles 102, 104, 106 to synchronize their clocks to each other well enough to create an ensemble time. Embodiments couple the clocks 126, 128, 130 on space vehicles using a radio frequency (RF) two-way timing (TWT) signal to form an ensemble time, and by extension improve the quality of an on-board Kalman filter. Embodiments improve the ensemble time by adding special relativity considerations to the ensemble time determination. Ensemble time determination is described and followed by a description of special relativity considerations and Kalman filter operations.

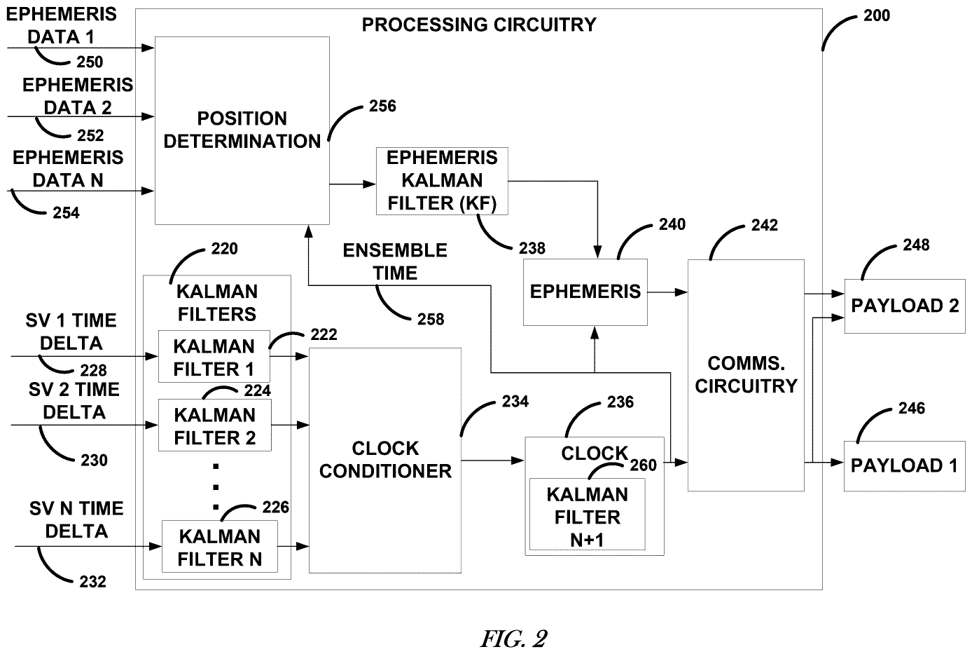

FIG. 2 illustrates, by way of example, a diagram of an embodiment of processing circuitry 200 to account for special relativistic effects in space vehicles. The processing circuitry 200 can be included with each of the space vehicles 102, 104, 106. The processing circuitry 200 as illustrated includes a bank of time Kalman filters 220, a clock conditioner 234, a clock 236, an ephemeris Kalman filter 238, ephemeris data 240, and communications circuitry 242.

The processing circuitry 200 builds the clock 236 and the ephemeris data 240 using the processing of measurements of time deltas 228, 230, 232. The measurements include time deltas 228, 230, 232, which are measurements of the ensemble time. Those time deltas 228, 230, 232 are processed through the clock Kalman filters 220. The Kalman filters 220, determining the state of the internal clock 236 as compared with the measurements of the ensemble time as determined by the time deltas 228, 230, 232. The time deltas 228, 230, 232 can include a time as reported by the space vehicles 102, 104, 106 and also a time delay component. The time delay component can correspond to an amount of time it takes for the time to be communicated from the space vehicle 102, 104, 106 to the space vehicle that houses the processing circuitry 200. The time delay can be determined as a difference between a time as provided by an internal clock 236 and a timestamp associated with the communication that provides the time (from an external space vehicle). The time states created by the n individual Kalman filters 222, 224, 226 are updated through the clock conditioner 234. On the alternate processing path, an ephemeris Kalman filter 238 processes the current measurements into an ephemeris state vector 240. Outputs from the processing circuitry 200 feed the various payloads 246, 248 of the space vehicle 102, 104, 106.

The set of Kalman filters 220 that includes Kalman filters 222, 224, 226 running in parallel that sample respective other clocks in the ensemble. That is, each Kalman filter 222, 224, 226 operates on clock data from a single space vehicle in the constellation. The ensemble time, as determined by the clock conditioner 234, becomes a means to correct the internal clock 236. After the clock 236 has reset, the processing circuitry resumes improving the space vehicle's clock 236 to be more consistent with the time of the constellation (an “ensemble time”). This process running over the space vehicles 102, 104, 106 of the ensemble makes these corrections on a space vehicle-by-space vehicle basis until the ensemble time maintains refreshes itself with high fidelity.

The Kalman filters 220 receive time deltas 228, 230, 232 from respective space vehicles 102, 104, 106. The time deltas 228, 230, 232 are sometimes called offsets. The Kalman filters 222, 224, 226 each determine a tau value that is then used by the clock conditioner 234 to adjust the internal clock 236 of the space vehicle 102, 104, 106. The output of each of the Kalman filters 222, 224, 226 can include first, second, and third order terms. The second order term is sometimes called the Allen deviation. Tau can be determined as in Equation 1:

$${tau}_{m n} ( t ) = {offset}_{0} + dt {offset}_{rate} + d {t}^{2} {offset}_{{rate}_{r a t e}} \qquad Equation 1$$

The tau from each of the Kalman filters 222, 224, 226 can be used to determine an amount to change the clock 236. The amount to change the clock 236 is sometimes called Δtₘ (time delta). Δtₘ can be determined as in Equation 2:

$$Δ {t}_{m} = \frac{1}{{q}_{m}} {\sum }_{i ∈ {Q}_{m}} Δ {t}_{m , i} = \frac{Δ {t}_{m 1} + Δ {t}_{m 2} + Δ {t}_{m 3} + … + Δ {t}_{m q m}}{{q}_{m}} \qquad Equation 2$$

The Kalman filter applies a Kalman gain, that weights the average time delta to determine how much the average time delta affects the system state. If the Kalman filter determines the new measurement is more noisy that it will affect the overall state less (it will weight its current state more than the new input noisy measurement).

Nominally the weighting of these Kalman filters are proportional to the inverses of their covariances. The smaller covariances will be weighted more heavily than the larger ones. The averaged time delta between the KF 222,224,226 will be the value that is passed on as a correction to the clock 236 provided by the conditioner 234.

The clock conditioner 234 can determine the time delta and apply the time delta to a clock time to generate a corrected clock time. The clock conditioner 234 receives all of the time delta values from the Kalman filters 222, 224, 226 and determines an average time delta based on the time delta values.

The tauₘₙ from Equation 1 is determined at the joint time of the concurrent tau calculations at each space vehicle of the constellation. So each clock of each space vehicle will have an offset from the time of the last Kalman entry defined by t0. That value will be tauₘₙ(t₀). This will be used for the Δt_{m,i} entries in Equation 2. Thus, the value Δtₘ becomes the ensemble offset for the clock 236 used in the clock conditioner 234. The ensemble clock offset is applied to the clock time of the clock 236 to generate an uncorrected ensemble time. The uncorrected ensemble time is provided to the clock Kalman filter 260. The clock Kalman filter 260 generates the ensemble time 258 based on the uncorrected ensemble time.

The ephemeris Kalman filter 238 receives the time delta and updates the ephemeris data (position and velocity data, sometimes including azimuth, elevation, or the like) of the space vehicle 102, 104, 106 accordingly. Ephemeris data 250, 252, 254 is provided to a position determination operator 256. The ephemeris data 250 can be provided with SV time delta 228 and from a first space vehicle of the constellation. The ephemeris data 252 can be provided with SV time delta 230 and from a second space vehicle of the constellation. The ephemeris data 254 can be provided with the SV time delta 232 and from a third space vehicle of the constellation.

The position determination operator 256 can determine a position, in space, of the processing circuitry 200 (that is part of yet another space vehicle). The position determination operator 256 can further receive the ensemble time 258 to determine the position of the vehicle when the vehicle is unable to communication with the ground station. The Kalman filter 238 provides a corrected position in space, the ephemeris data 240, based on the ensemble time 258 and the determined position, in space, from the position determination operator 256.

The position determination operator 256 can use a relativistic boost matrix, discussed elsewhere, to alter the ephemeris data 250, 252, 254 and account for special relativity between the space vehicle motion. Note that an error in time, in the nanosecond range, makes the position determination off in the meter range. Accordingly, even a small error in time can the ephemeris 240 to be off by an appreciable amount. Thus, it is important to have position, velocity, and time determinations that account for special relativistic effects.

The ephemeris data 240 and the clock data 236 are then provided, by communications circuitry 242, either individually or in combination, as a payload 246, 248 to other space vehicles 102, 104, 106, the ground station 108, or the like.

The communications circuitry 242 can include electric or electronic components for wireless data communication. The electric or electronic components can include a resistor, transistor, capacitor, diode, inductor, amplifier, power circuitry, memory device, a transceiver, an antenna 120, 122, 124, modulator, a combination thereof, or the like.

The clock 236 operates using a Kalman filter 260 to determine an predicted time based on a time estimate from the clock 236 and the ensemble time from the clock conditioner. The clock 236 provides the time used to estimate position, velocity, and timing accuracy (PVTA) by the position determination operator 256.

The processing circuitry 200 can include electrical components configured to perform the operations on the received data. The processing circuitry 200 can include one or more resistors, transistors, capacitors, diodes, inductors, logic gates (e.g., AND, OR, XOR, negate, buffer, or the like), regulators (e.g., voltage, current, or power), amplifiers, power supplies, analog to digital converters, digital to analog converters, multiplexers, switches, buck or boost converters, or the like. The processing circuitry 200 can include a processing unit, such as can include one or more central processing units (CPUs), graphics processing units (GPUs), field programmable gate arrays (FPGAs), application specific integrated circuits (ASICs), or the like. Two or more of the processing units can operate in different number systems, such as in parallel.

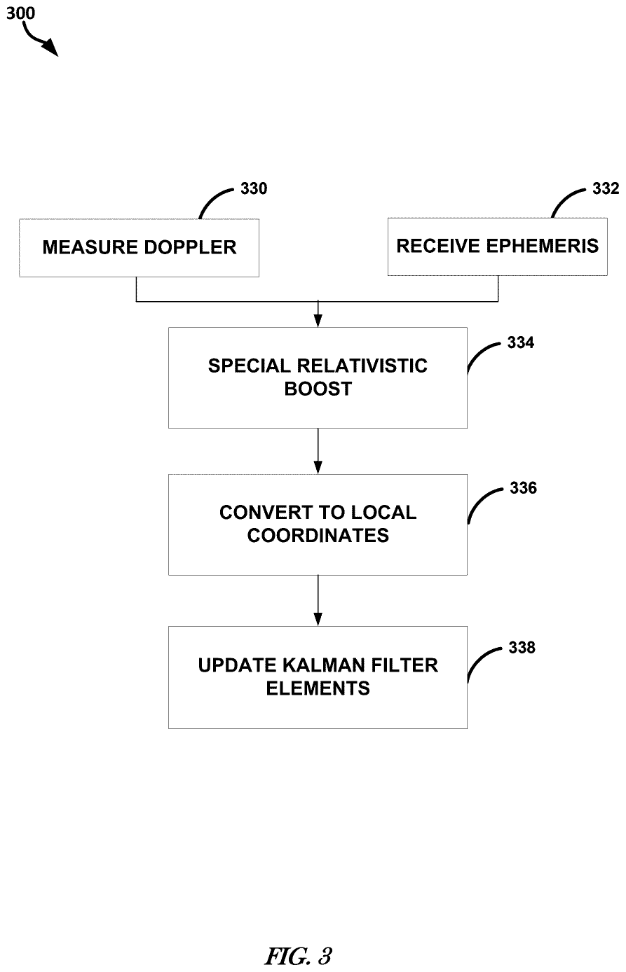

FIG. 3 illustrates, by way of example, a flow diagram of a method 300 for special relativity consideration in ensemble time determination. The method 300 as illustrated includes measuring Doppler 330 between satellites that are communicating clock times with each other, receiving Ephemeris 332 from the satellite communicating the clock time, determining special relativistic boost 334, converting to local coordinates 336, and updating Kalman filter elements 338.

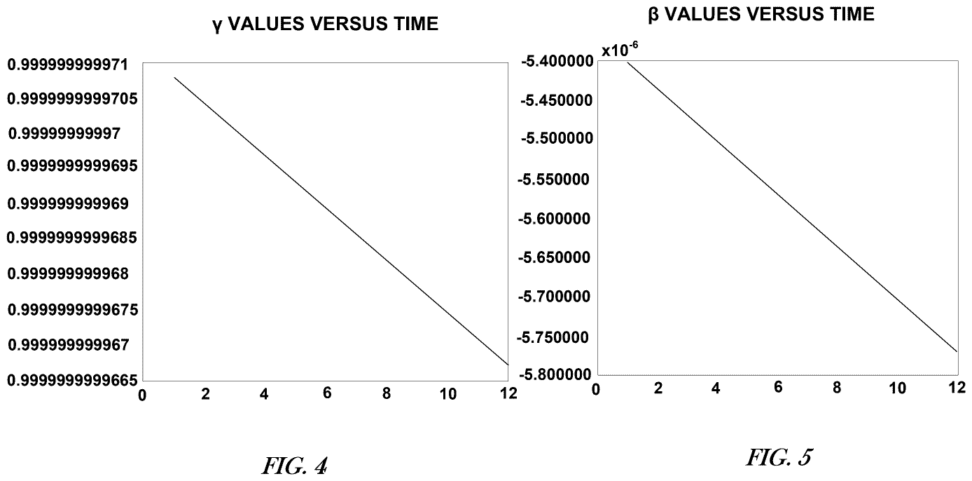

Doppler 330 measurements account for the Doppler effect. The Doppler effect is an increase (or decrease) in the frequency of sound, light, or other waves as a source and observer move toward (or away from) each other. The Doppler effect accounts, for example, for a sudden change in pitch noticeable in a passing siren, as well as a redshift seen by astronomers. Measuring the Doppler 330 provides a receiving space vehicle with an understanding of the relative speeds between the source space vehicle (the space vehicle issuing a communication) and the receiving space vehicle. The Doppler shift of a center frequency of space vehicle communications defines the relative velocity between two space vehicles. The Doppler formula used to determine the special relativistic velocity between the space vehicles is:

$$\frac{{f}_{s}}{{f}_{r}} = \sqrt{( 1 + β ) / ( 1 - β )} .$$

where β=v/c and γ=1/\sqrt{1−β²} and fₛ is the frequency of the communication from the sender and fᵣ is the frequency of communication perceived by the receiver. Typically, γ is used as the relativity parameter. However, because β is typically much less than 1, γ is very close to 1. So close to 1, in practice, γ only varies from 1 in about the tenth decimal place or more. β, in contrast to γ varies more typically out to and including the 5th or 6th decimal place. This means that when β is used as input to a Kalman filter, a covariance determined by the Kalman filter is more varied than the covariance determined when γ is used as input to the Kalman filter. The differences between variation in γ and β are illustrated in FIG. 4.

The ephemeris data 332 indicates the position and velocity (speed and direction) of a space vehicle. The ephemeris data received at the space vehicle need to be converted to an instantaneous value in the coordinate system of the receiver. The conversion can be for use by the ephemeris Kalman filter 238. If the TWT includes ranging activity (e.g., radar, LIDAR, or the like), special relativistic corrections can be applied to the ranging data as well.

The special relativistic boost 334 can be determined based on γ, β, or a combination thereof. The special relativistic boost can be applied to ephemeris, clock, ranging, or other data to convert the data to a local coordinate system. An example relativistic boost. As previously discussed, a prior relativistic boost relied strictly on γ and does not provide elements that measurably co-vary, whereas use of β or β² provides relativistic boost elements (entries in the relativistic boost equation) that do measurably co-vary. This means that the Kalman filter output is actually affected by using β and the time, position, or combination thereof is affected by special relativity considerations. An example of a special relativistic boost equation is provided:

$${A}_{boost} ( β ) = [ \begin{matrix}γ & - {γβ}_{x} & - {γβ}_{y} & - {γβ}_{z} \\ - {γβ}_{x} & 1 + \frac{( γ - 1 ) {β}_{x}^{2}}{{β}^{2}} & \frac{( γ - 1 ) {β}_{x} {β}_{y}}{{β}^{2}} & \frac{( γ - 1 ) {β}_{x} {β}_{z}}{{β}^{2}} \\ - {γβ}_{y} & \frac{( γ - 1 ) {β}_{y} {β}_{x}}{{β}^{2}} & 1 + \frac{( γ - 1 ) {β}_{y}^{2}}{{β}^{2}} & \frac{( γ - 1 ) {β}_{y} {β}_{z}}{{β}^{2}} \\ - {γβ}_{z} & \frac{( γ - 1 ) {β}_{z} {β}_{x}}{{β}^{2}} & \frac{( γ - 1 ) {β}_{z} {β}_{y}}{{β}^{2}} & 1 + \frac{( γ - 1 ) {β}_{z}^{2}}{{β}^{2}}\end{matrix} ]$$

Converting to local coordinates 336 includes applying the special relativity boost matrix, A_{boost}(β), to the ephemeris, time, or other data. IN mathematical terms this means Δx′=A_{boost}(β)Δx, where Δx is the measurement data (position, velocity, or time data) from the other space vehicle.

Updating Kalman filter elements 338 includes applying the special relativity matrix to all relevant Kalman filter entries. This means that β is an input parameter for the Kalman filter. Further, the special relativity matrix, A_{boost}(β), can be used as an input for the Kalman filter.

FIGS. 4 and 5 illustrate graphs that plot actual γ and β values, respectively, along with their relative variation. As can be seen, the variation in γ is multiple orders of magnitude smaller than the variation in β. In fact, the variation in γ is so small that a special relativity matrix determined based on γ is very close to an identity matrix, varying in the 10th, or even less significant decimal point. In contrast, the variation in β is seen in a much more significant decimal point, about four or five orders of magnitude more significant than the variation realized using γ.

A description of Kalman filter 222, 224, 226, 238 operation is now provided with reference to two prediction equations and three update equations.

\hat{x}_{k|k-1}=Φ\hat{x}_{k-1|k-1}+Bₖuₖ State Prediction Equation

P_{k|k-1}=ΦP_{k-1|k-1}Φ^{T}+Qₖ Covariance Prediction Equation

Kₖ=P_{k|k-1}H^{T}(HP_{k|k-1}H^{T}+Rₖ)⁻¹ Determine Kalman Gain

\hat{x}_{k|k}=\hat{x}_{k|k-1}+Kₖ(zₖ−H\hat{x}_{k|k-1}) Update State Vector

P_{k|k}=(I−KₖH)P_{k|k-1} Update Covariance

In these Kalman Filter Equations Bₖ is the control-input model, Qₖ is the process noise covariance, uₖ is a control vector, Rₖ is white noise covariance, \hat{x} is a state vector, Φ is a state transition matrix, K is the Kalman gain, H is a state-to-measurement matrix, z is measurements of the state to be predicted, and P is the covariance.

Note that if the covariance P is large, the Kalman gain, K, is reduced and the Kalman gain turns down the contributions of the measurements, z. z, for example is the time delta 228, 230, 232, or the ephemeris data provided to the ephemeris Kalman filter 238.

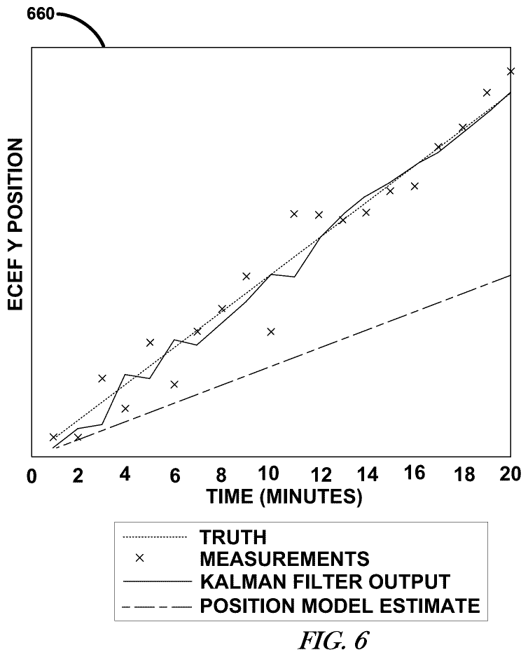

FIG. 6 illustrates, by way of example, a graph 660 of space vehicle position determination using Kalman filter operations that can help understand the operations of Kalman filters. As can be seen, the Kalman filter prediction starts out about as accurate as a model estimate. Shortly thereafter, the Kalman filter prediction is much more accurate than the model. This is because the measurements are more accurate than the model and the Kalman gain “understands” that the model is to have a reduced weighting based on the covariance. Eventually, the Kalman filter prediction is quite close to the truth.

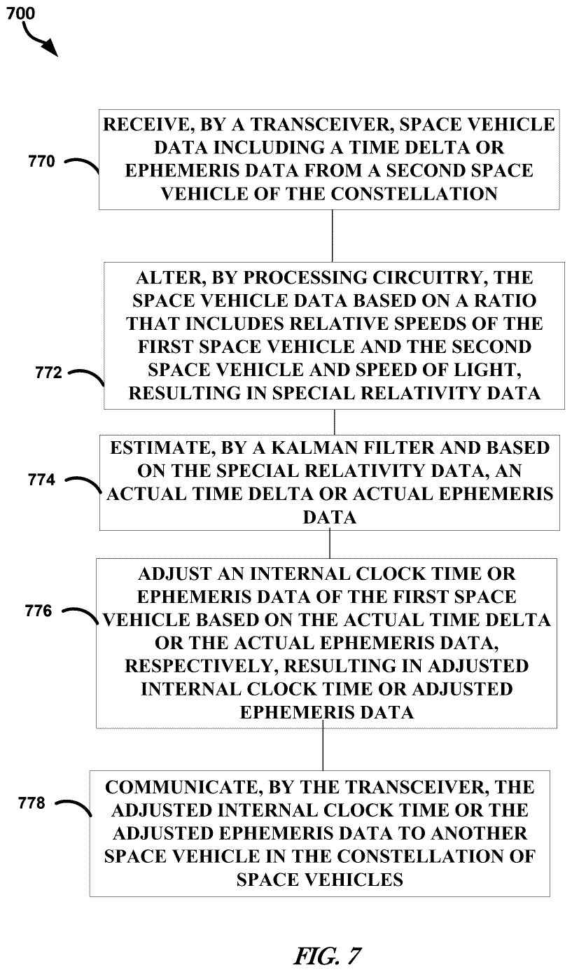

FIG. 7 illustrates, by way of example, a diagram of an embodiment of a method 700 for improved space vehicle time or ephemeris data determination that accounts for special relativity. The method 700 as illustrated includes receiving, by a transceiver, space vehicle data including a time delta or ephemeris data from a second space vehicle of the constellation, at operation 770; altering, by processing circuitry, the space vehicle data based on a ratio that includes relative speeds of the first space vehicle and the second space vehicle and speed of light, resulting in special relativity data, at operation 772; estimating, by a Kalman filter and based on the special relativity data, an actual time delta or actual ephemeris data, at operation 774; adjusting an internal clock time or ephemeris data of the first space vehicle based on the actual time delta or the actual ephemeris data, respectively, resulting in adjusted internal clock time or adjusted ephemeris data, at operation 776; and communicating, by the transceiver, the adjusted internal clock time or the adjusted ephemeris data to another space vehicle in the constellation of space vehicles, at operation 778.

The space vehicle data can include the time delta. The space vehicle data can include the ephemeris data. The relative speeds can be a magnitude of an addition of velocity vectors of the first space vehicle and the second space vehicle. The operation 772 can include determining a relativity boost matrix that indicates a change in position for the second space vehicle in three dimensions. The operation 776 can include multiplying the ephemeris data by the relativity boost matrix. The operation 774 can include providing the relativity boost matrix as input to the Kalman filter.

If one has γ or β they can get the other. The relations for γ and β are

$$γ = \frac{1}{\sqrt{1 - {β}^{2}}}$$

and

$$β = \sqrt{1 - \frac{1}{{γ}^{2}}}$$

(though β is destroyed by roundoff). Since β≈1×10⁻⁵ or 1×10⁻⁶, γ will be exceedingly close to 1 and what one really cares about is that part of γ that differs from 1.

So, it is beneficial for one to work with one or the other of the two variables γ₁=γ−1 or γ₂₁=γ²−1. If one has γ or β they can get γ₁ and γ₂₁.

One can really care about γ₁=γ−1 or perhaps γ₂₁=γ²−1. Either way, these values would decrease roundoff errors and γ does not. Note that both are ≈1×10⁻¹⁰ or 1×10⁻¹² so that if one works directly with γ using 10 to 12 significant figures, they lose the entire meaning of γ and all we have is γ=1. The change in a clock time from one system to another will be in the 10th to 12th figure and it is precisely this quantity that one wants to have several significant figures of.

Since γ=γ₁+1 and

$${γ}^{2} = {( {γ}_{1} + 1 )}^{2} = 1 + 2 {γ}_{1} + {γ}_{1}^{2} \approx 1 + 2 {γ}_{1}$$

one can get γ and γ² from γ₁. One might be tempted to approximate γ²≈1+2γ₁ resulting in an error in the 10th to 12th place. Since this does not appreciably simplify the formula there is no reason to do this. Also, if one has γ₂₁ then they can get γ² by using γ²=γ₂₁+1.

Getting γ from γ₂₁ is more involved but the real need is to be able to get γ₁ from γ₂₁. The easy transformation from γ₁ to γ₂₁ is to use

$${γ}_{21} = ( γ - 1 ) ( γ + 1 ) = {γ}_{1} ( {γ}_{1} + 2 ) = 2 {γ}_{1} + {γ}_{1}^{2} .$$

An interesting case is this:

$${γ}_{1} = γ - 1 = \frac{{γ}^{2} - 1}{γ + 1} = \frac{{γ}_{21}}{1 + \sqrt{1 + {γ}_{21}}} .$$

Here, in determining γ₁, one has avoided subtracting two nearly equal numbers. Notice that this last formula is exact, avoids as much roundoff as possible, and is not obvious. One can, of course, add 1 to this to get γ, but we are trying to avoid this.

Now it is true that

$$β = \sqrt{1 - \frac{1}{{γ}^{2}}}$$

but in this form, β loses significant figures from the subtraction of two numbers close to 1 (one of which is 1, itself). To avoid this loss, one replace the radicand with

$$\frac{{γ}^{2} - 1}{{γ}^{2}}$$

giving

$$β = \frac{\sqrt{{γ}_{21}}}{1 + {γ}_{1}} .$$

This is fine if one has γ₁ as they may replace the radicand with

$$2 {γ}_{1} + {γ}_{1}^{2}$$

(which is near 2γ₁, by the way).

Another relation is how to recover γ₁ from γ₂₁.

$${γ}_{21} = {γ}^{2} - 1 = \frac{{β}^{2}}{1 - {β}^{2}}$$

$${β}^{2} = \frac{{γ}^{2} - 1}{1 + ( {γ}^{2} - 1 )} = \frac{{γ}_{21}}{1 + {γ}_{21}}$$

$${γ}_{1} = γ - 1 = \frac{{γ}^{2} - 1}{1 + \sqrt{1 + ( {γ}^{2} - 1 )}} = \frac{{γ}_{21}}{1 + \sqrt{1 + {γ}_{21}}}$$

$$\begin{matrix}{γ}_{1} = \frac{{β}^{2}}{( 1 + \sqrt{1 - {β}^{2}} ) \sqrt{1 - {β}^{2}}} \\ {γ}_{1} = \frac{{β}^{2}}{1 + \sqrt{1 - {β}^{2}} - {β}^{2}}\end{matrix}$$

To convert coordinates to a receiving space vehicle, a boost equation (sometimes called a boost matrix) is applied to ephemeris data. In mathematical terms this is expressed as Δx′=A_{boost}(β)Δx, where Δx is the measurement data (position, velocity, or time data) from the other space vehicle. The value of the boost matrix is exceedingly close to the identity matrix when using γ. Since the change is exceedingly small, one can compute the change, δ=Δx′−Δx, directly without the matrix multiply shown. Then δ can be added to Δx. Avoiding “losing some of the delta” in doing this addition takes some effort. The calculation of delta by itself can be done with great accuracy. The space vehicle can determine and filter the object B=A_{boost}(β)−I₄. This object is given by the following equation:

$$B = [ \begin{matrix}γ - 1 & - {γβ}_{x} & - {γβ}_{y} & - {γβ}_{z} \\ - {γβ}_{x} & \frac{( γ - 1 ) {β}_{x}^{2}}{{β}^{2}} & \frac{( γ - 1 ) {β}_{x} {β}_{y}}{{β}^{2}} & \frac{( γ - 1 ) {β}_{x} {β}_{z}}{{β}^{2}} \\ - {γβ}_{y} & \frac{( γ - 1 ) {β}_{y} {β}_{x}}{{β}^{2}} & \frac{( γ - 1 ) {β}_{y}^{2}}{{β}^{2}} & \frac{( γ - 1 ) {β}_{y} {β}_{z}}{{β}^{2}} \\ - {γβ}_{z} & \frac{( γ - 1 ) {β}_{z} {β}_{x}}{{β}^{2}} & \frac{( γ - 1 ) {β}_{z} {β}_{y}}{{β}^{2}} & \frac{( γ - 1 ) {β}_{z}^{2}}{{β}^{2}}\end{matrix} ] = \\ [ \begin{matrix}0 & - {β}_{x} & - {β}_{y} & - {β}_{z} \\ - {β}_{x} & 0 & 0 & 0 \\ - {β}_{y} & 0 & 0 & 0 \\ - {β}_{z} & 0 & 0 & 0\end{matrix} ] + \text{} ( γ - 1 ) [ \begin{matrix}1 & - {β}_{x} & - {β}_{y} & - {β}_{z} \\ - {β}_{x} & \frac{{β}_{x}^{2}}{{β}^{2}} & \frac{{β}_{x} {β}_{y}}{{β}^{2}} & \frac{{β}_{x} {β}_{z}}{{β}^{2}} \\ - {β}_{y} & \frac{{β}_{y} {β}_{x}}{{β}^{2}} & \frac{{β}_{y}^{2}}{{β}^{2}} & \frac{{β}_{y} {β}_{z}}{{β}^{2}} \\ - {β}_{z} & \frac{{β}_{z} {β}_{x}}{{β}^{2}} & \frac{{β}_{z} {β}_{y}}{{β}^{2}} & \frac{{β}_{z}^{2}}{{β}^{2}}\end{matrix} ] = {B}_{1} + ( γ - 1 ) {b}_{2}$$

All occurrences of γ and of γ−1 in these expressions should be computed via the formula γ₁=β²/(1+\sqrt{1−β²}−β²) where γ₁ is defined to be γ₁=γ−1. Notice that B₁ lives near 10**−5 or 10**−6 and that γ₁=γ−1 lives near 10**−11 give or take a few places.

Here B₁ is the two-by-two block matrix with 0 and the 3 by 3 zero matrix on the diagonal and the off-diagonal blocks are the beta vector and its transpose:

$${B}_{1} = [ \begin{matrix}0 & - {β}^{T} \\ - β & {0}_{3}\end{matrix} ]$$

While the B₂ matrix differs from the B₁ matrix in that it has a 1 in the 1-1 position and the lower right 3 by 3 block is given by the anti-scalar product of the unit beta vector with its transpose.

$${B}_{2} = [ \begin{matrix}1 & - {β}^{T} \\ - β & \frac{{ββ}^{T}}{{β}^{2}}\end{matrix} ]$$

At this point the sizes of the various terms can be considered. The boost matrix itself is, to first order, the 4 by 4 identity matrix. The matrices B and B₁ get their sizes from β≈1×10⁻⁵ or 1×10⁻⁶, are nearly equal, and differ by (γ−1)B₂. This last matrix has size governed by the facts that γ−1=γ₁≈1×10⁻¹⁰ or 1×10⁻¹² and the entries of B₂ are bounded by 1's on the block diagonal parts and by β≈1×10⁻⁵ or 1×10⁻⁶ for the off-diagonal vectors.

If one can work with B and B₁ in place of the boost matrix they will be assured of an additional 5 or 6 significant figures over A, and possibly double that improvement. The change of state between the relativistic reference frames becomes

$$δ = Δ {x}^{′} - Δ x = {A}_{boost} ( β ) Δ x - Δ x = ( {A}_{boost} ( β ) - {I}_{4} ) Δ x = Bx Thus$$

$$δ = Bx = {B}_{1} x + ( γ - 1 ) {B}_{2} x .$$

The deltas from successive frame changes are cumulative and will all have had an extra 5 to 6 significant figures retained so that cumulative round-off over multiple frame changes will be minimized.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

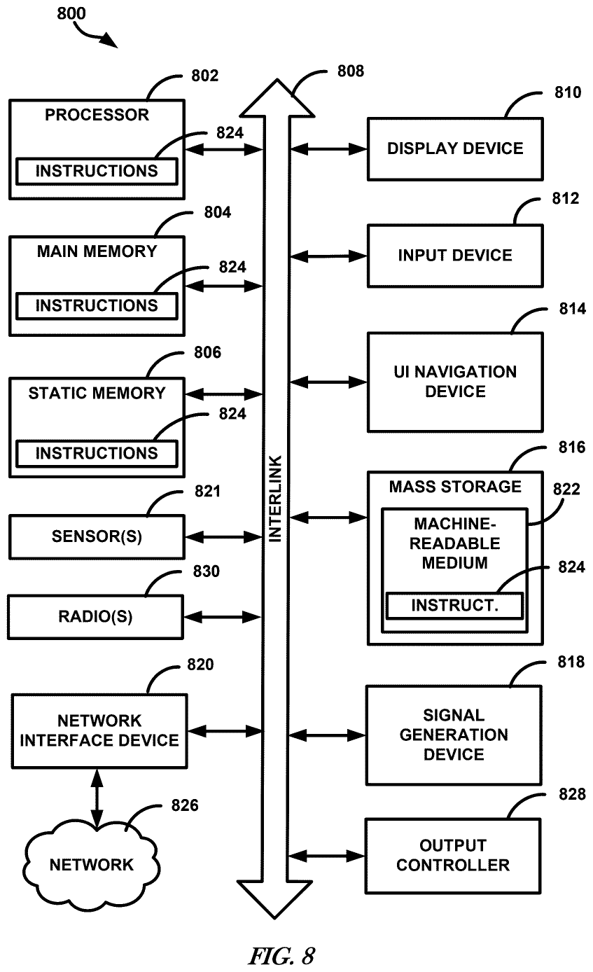

FIG. 8 illustrates, by way of example, a block diagram of an embodiment of a machine in the example form of a computer system 800 within which instructions, for causing the machine to perform any one or more of the methodologies discussed herein, may be executed. One or more of the components of the space vehicles 102, 104, 106, processing circuitry 200, method 300, 700, or a component or operation thereof can be implemented or performed by the computer system 800. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 621 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 804 and a static memory 806, which communicate with each other via a bus 808. The memory 804, 806 can store parameters (sometimes called weights) that define operations of the processing circuitry 200, or other component of the system 800. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker), a network interface device 820, and radios 830 such as Bluetooth, WWAN, WLAN, and NFC, permitting the application of security controls on such protocols.

The machine 800 as illustrated includes an output controller 828. The output controller 828 manages data flow to/from the machine 800. The output controller 828 is sometimes called a device controller, with software that directly interacts with the output controller 828 being called a device driver.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804, the static memory 806, and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Example

Example 1 can include a space vehicle comprising a transceiver configured to receive space vehicle data including a time delta or ephemeris data from a second space vehicle, and processing circuitry configured to alter the space vehicle data based on a ratio that includes relative speeds of the space vehicle and the second space vehicle and speed of light, resulting in special relativity data, estimate, by a Kalman filter and based on the special relativity data, an actual time delta or actual ephemeris data, and adjusting an internal clock time or ephemeris data of the space vehicle based on the actual time delta or the actual ephemeris data, respectively, resulting in adjusted internal clock time or adjusted ephemeris data, wherein the transceiver is configured to communicate the adjusted internal clock time or the adjusted ephemeris data to another space vehicle in a constellation of space vehicles that includes the space vehicle and the second space vehicle.

In Example 2, Example 1 can further include, wherein the space vehicle data includes the time delta.

In Example 3, at least one of Examples 1-2 can further include, wherein the space vehicle data includes the ephemeris data.

In Example 4, at least one of Examples 1-3 can further include, wherein the relative speeds is a magnitude of an addition of velocity vectors of the space vehicle and the second space vehicle.

In Example 5, at least one of Examples 1-4 can further include, wherein altering the space vehicle data includes determining a relativity boost matrix that indicates a change in position for the second space vehicle in three dimensions.

In Example 6, Example 5 further includes, wherein adjusting the ephemeris data includes multiplying the ephemeris data by the relativity boost matrix.

In Example 7, Example 6 further includes, wherein the estimating the actual time delta or the actual ephemeris data includes providing the relativity boost matrix as input to the Kalman filter.

Example 8 includes a method performed by a first space vehicle of a constellation of space vehicles, the method comprising receiving, by a transceiver, space vehicle data including a time delta or ephemeris data from a second space vehicle of the constellation, altering, by processing circuitry, the space vehicle data based on a ratio that includes relative speeds of the first space vehicle and the second space vehicle and speed of light, resulting in special relativity data, estimating, by a Kalman filter and based on the special relativity data, an actual time delta or actual ephemeris data, and adjusting an internal clock time or ephemeris data of the first space vehicle based on the actual time delta or the actual ephemeris data, respectively, resulting in adjusted internal clock time or adjusted ephemeris data, and communicating, by the transceiver, the adjusted internal clock time or the adjusted ephemeris data to another space vehicle in the constellation of space vehicles.

In Example 9, Example 8 further includes, wherein the space vehicle data includes the time delta.

In Example 10, at least one of Examples 8-9 further includes, wherein the space vehicle data includes the ephemeris data.

In Example 11, at least one of Examples 8-10 further includes, wherein the relative speeds is a magnitude of an addition of velocity vectors of the first space vehicle and the second space vehicle.

In Example 12, at least one of Examples 8-11 further includes, wherein altering the space vehicle data includes determining a relativity boost matrix that indicates a change in position for the second space vehicle in three dimensions.

In Example 13, Example 12 further includes, wherein adjusting the ephemeris data includes multiplying the ephemeris data by the relativity boost matrix.

In Example 14, Example 13 further includes, wherein the estimating the actual time delta or the actual ephemeris data includes providing the relativity boost matrix as input to the Kalman filter.

Example 15 includes a (e.g., non-transitory) machine-readable medium including instructions that, when executed by a machine, cause the machine to perform the method of one of Examples 8-14.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A space vehicle comprising:
a transceiver configured to receive space vehicle data including a time delta or ephemeris data from a second space vehicle; and
processing circuitry configured to:
alter the space vehicle data based on a ratio that includes relative speeds of the space vehicle and the second space vehicle and speed of light, resulting in special relativity data;
estimate, by a Kalman filter and based on the special relativity data, an actual time delta or actual ephemeris data; and
adjusting an internal clock time or ephemeris data of the space vehicle based on the actual time delta or the actual ephemeris data, respectively, resulting in adjusted internal clock time or adjusted ephemeris data; and
wherein the transceiver is configured to communicate the adjusted internal clock time or the adjusted ephemeris data to another space vehicle in a constellation of space vehicles that includes the space vehicle and the second space vehicle.

2. The space vehicle of claim 1, wherein the space vehicle data includes the time delta.

3. The space vehicle of claim 1, wherein the space vehicle data includes the ephemeris data.

4. The space vehicle of claim 1, wherein the relative speeds is a magnitude of an addition of velocity vectors of the space vehicle and the second space vehicle.

5. The space vehicle of claim 1, wherein altering the space vehicle data includes determining a relativity boost matrix that indicates a change in position for the second space vehicle in three dimensions.

6. The space vehicle of claim 5, wherein adjusting the ephemeris data includes multiplying the ephemeris data by the relativity boost matrix.

7. The space vehicle of claim 6, wherein the estimating the actual time delta or the actual ephemeris data includes providing the relativity boost matrix as input to the Kalman filter.

8. A method performed by a first space vehicle of a constellation of space vehicles, the method comprising:
receiving, by a transceiver, space vehicle data including a time delta or ephemeris data from a second space vehicle of the constellation;
altering, by processing circuitry, the space vehicle data based on a ratio that includes relative speeds of the first space vehicle and the second space vehicle and speed of light, resulting in special relativity data;
estimating, by a Kalman filter and based on the special relativity data, an actual time delta or actual ephemeris data; and
adjusting an internal clock time or ephemeris data of the first space vehicle based on the actual time delta or the actual ephemeris data, respectively, resulting in adjusted internal clock time or adjusted ephemeris data; and
communicating, by the transceiver, the adjusted internal clock time or the adjusted ephemeris data to another space vehicle in the constellation of space vehicles.

9. The method of claim 8, wherein the space vehicle data includes the time delta.

10. The method of claim 8, wherein the space vehicle data includes the ephemeris data.

11. The method of claim 8, wherein the relative speeds is a magnitude of an addition of velocity vectors of the first space vehicle and the second space vehicle.

12. The method of claim 8, wherein altering the space vehicle data includes determining a relativity boost matrix that indicates a change in position for the second space vehicle in three dimensions.

13. The method of claim 12, wherein adjusting the ephemeris data includes multiplying the ephemeris data by the relativity boost matrix.

14. The method of claim 13, wherein the estimating the actual time delta or the actual ephemeris data includes providing the relativity boost matrix as input to the Kalman filter.

15. A non-transitory machine-readable medium including instructions that, when executed by processing circuitry of a first space vehicle of a constellation of space vehicles, causes the processing circuitry to perform operations of special relativity compensation, the operations comprising:
receiving space vehicle data including a time delta or ephemeris data from a second space vehicle of the constellation;
altering the space vehicle data based on a ratio that includes relative speeds of the first space vehicle and the second space vehicle and speed of light, resulting in special relativity data;
estimating, by a Kalman filter and based on the special relativity data, an actual time delta or actual ephemeris data;
adjusting an internal clock time or ephemeris data of the first space vehicle based on the actual time delta or the actual ephemeris data, respectively, resulting in adjusted internal clock time or adjusted ephemeris data; and
communicating the adjusted internal clock time or the adjusted ephemeris data to another space vehicle in the constellation of space vehicles.

16. The non-transitory machine-readable medium of claim 15, wherein the space vehicle data includes the time delta.

17. The non-transitory machine-readable medium of claim 15, wherein the space vehicle data includes the ephemeris data.

18. The non-transitory machine-readable medium of claim 15, wherein the relative speeds is a magnitude of an addition of velocity vectors of the first space vehicle and the second space vehicle.

19. The non-transitory machine-readable medium of claim 15, wherein altering the space vehicle data includes determining a relativity boost matrix that indicates a change in position for the second space vehicle in three dimensions.

20. The non-transitory machine-readable medium of claim 19, wherein adjusting the ephemeris data includes multiplying the ephemeris data by the relativity boost matrix.
